(19) United States
(12) Patent Application Publication
(10) Pub. No.: US 2012/0177849 A1
(43) Pub. Date: Jul. 12, 2012

(54) System to introduce scent into abient air

(76) Inventor: Gary Joseph Pannuzzo, Chatham, NJ (US)

(21) Appl. No.: 13/373,525

(22) Filed: Nov. 17, 2011

Related U.S. Application Data
(63) Continuation-in-part of application No. 13/134,395, filed on Jun. 7, 2011, now abandoned.
(60) Provisional application No. 61/397,163, filed on Jun. 8, 2010.

(51) Int. Cl. A47G 33/04; B23P 11/00

(52) U.S. Cl. 428/7; 29/428

(57) ABSTRACT

A multi-component auxiliary fragrance dispensing containment system is configured to be removably assembled and secured to and circumscribe the trunk of an existing erected live or artificial coniferous Christmas tree. The Christmas tree includes decorations. The containment system conceals an air fragrance composition mounted within the containment system intermediate the trunk of the Christmas tree and a wall of the containment system.

This application is a continuation-in-part of application Ser. No. 13/134,395, filed Jun. 7, 2011, which claims priority based upon U.S. Provisional Patent Application Ser. No. 61/397,163, filed Jun. 8, 2010.

Aerosol sprays, scented candles, incense, potpourri, free standing room air fresheners, and many other means of introducing a scent into the ambient air in or around a residence or other building structure have been developed over the years, and those of skill in the art have during that period of time continued to investigate improving apparatus and methodologies to accomplish the same.

Accordingly, it would be highly desirable to provide a new improved system and method to introduce a scent into the ambient air.

Therefore, it is a principal object of the invention to develop a novel system and method to introduce at least one scent into the ambient air.

This and other, further and more specific objects and advantages of the invention will be apparent to those skilled in the art from the following detailed description thereof, taken in conjunction with the drawings, in which:

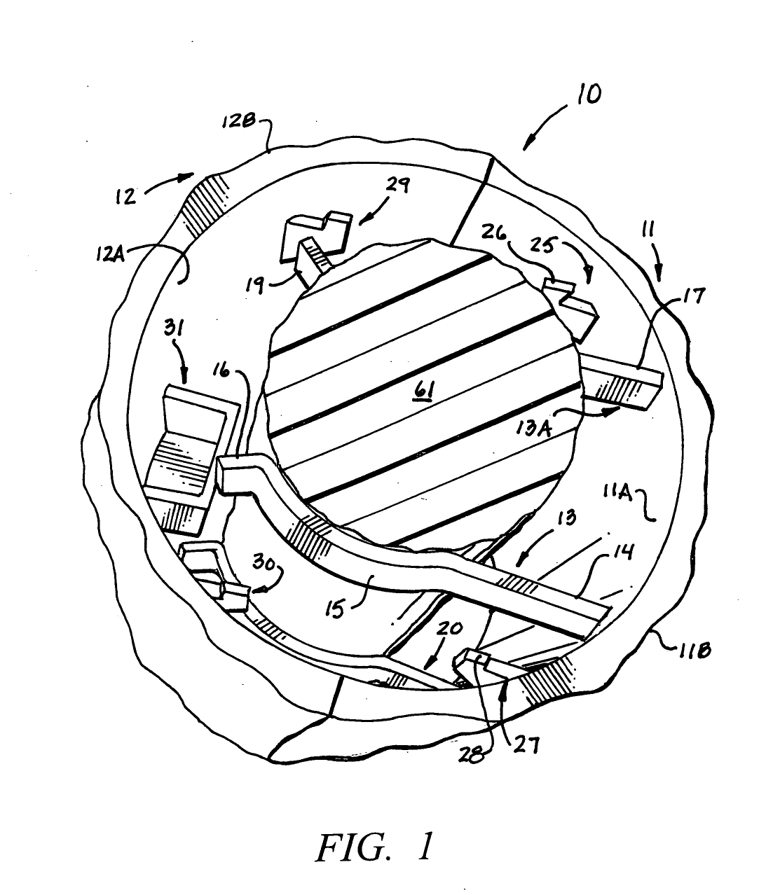

FIG. 1 is a top, partial section view illustrating a system constructed in accordance with the principles of the invention;

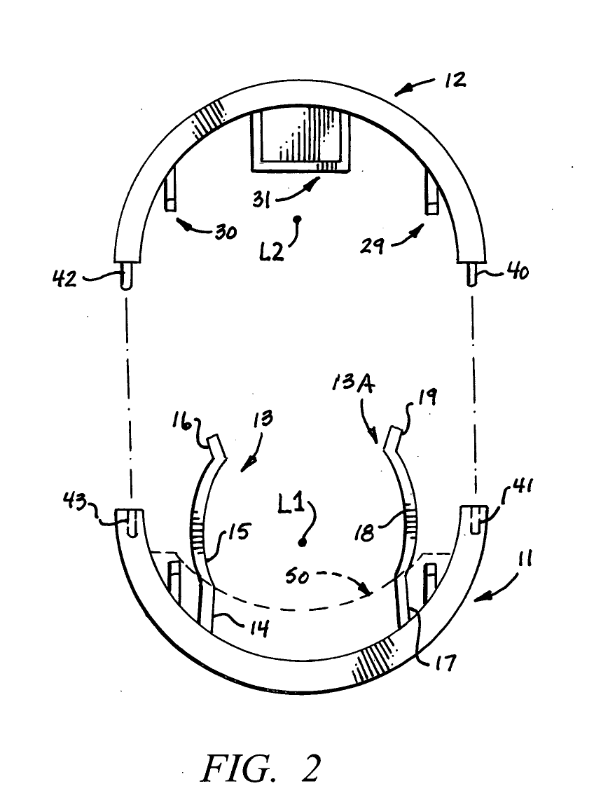

FIG. 2 is an exploded top view illustrating the mode of operation of apparatus utilized in the invention;

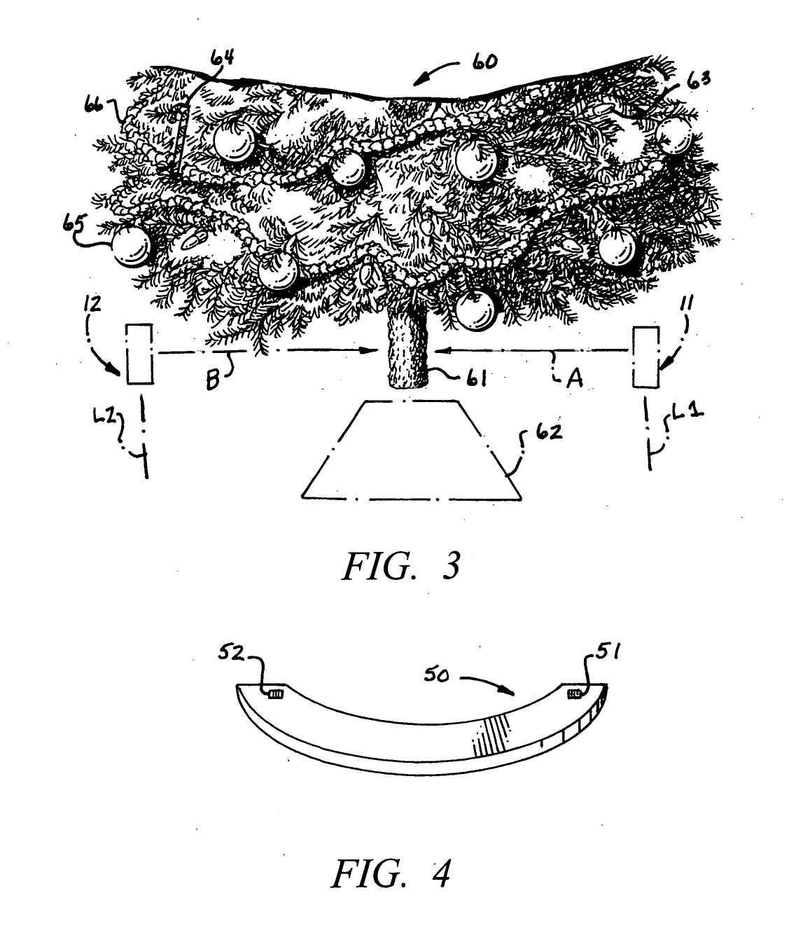

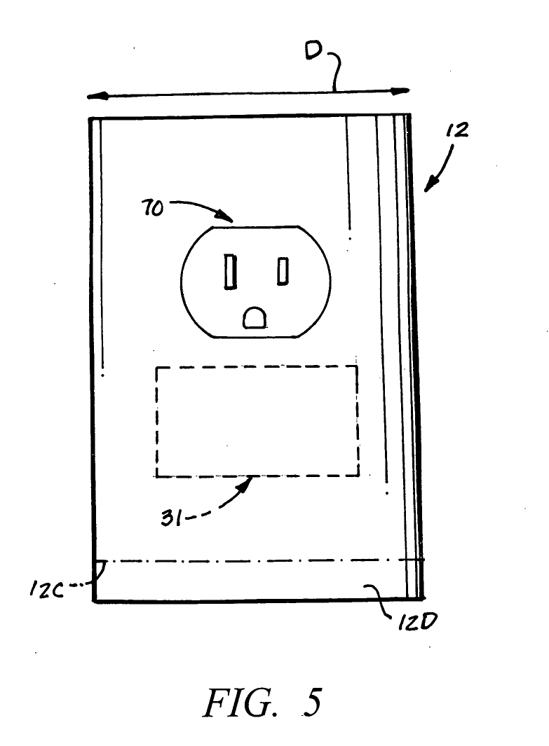

FIG. 3 is a side view further illustrating the mode of operation of the invention;

FIG. 4 is a perspective view illustrating auxiliary apparatus utilized in the invention; and,

FIG. 5 is a side view illustrating auxiliary electrical apparatus utilized in the practice of the invention.

Briefly, in accordance with one embodiment of the invention, I provide an improved system to introduce a scent into the ambient air. The system includes a coniferous generally conically shaped Christmas tree. The tree comprises a trunk with an upper portion having a plurality of outwardly extending branches, and a lower portion generally free of outwardly extending branches. The trunk has a generally vertically oriented longitudinal axis. The Christmas tree also comprises a plurality of decorations on the tree including Christmas tree lights.

The scent-introduction system of the invention also includes a Christmas tree stand receiving the trunk and supporting the Christmas tree; includes a first arcuate generally semi-cylindrical wall having an inner concave surface and an outer convex surface; and, includes at least one pair of spaced apart clips. The clips are connected to and extend outwardly from the inner concave surface normal to the longitudinal axis of the trunk; and, engage the lower portion of the Christmas tree trunk to removably secure the first wall to the trunk such that the first wall partially circumferentially extends around the lower portion of the trunk.

The scent-introduction system of the invention also includes a second arcuate generally semi-cylindrical wall having an inner concave surface and an outer convex surface and removably connected to the first wall such that the first and second walls collectively extend substantially entirely around the trunk.

The scent-introduction system of the invention also includes air freshener concealed within the first and second walls, and intermediate at least one of the walls and the trunk.

In another embodiment of the invention, I provide an improved method to introduce a scent into the ambient air. The method includes the step of providing a coniferous generally conically shaped tree. The tree comprises a trunk with an upper portion having a plurality of outwardly extending branches, and a lower portion generally free of outwardly extending branches. The trunk has a generally vertically oriented first longitudinal axis. The tree also includes a plurality of decorations on the tree including Christmas tree lights, which decorations in combination with the coniferous tree produce a Christmas tree.

The scent-introduction method of the invention also includes providing a Christmas tree stand to receive the trunk and support the Christmas tree; includes mounting the Christmas tree in the Christmas tree stand; and, includes providing a first arcuate generally semi-cylindrical wall. The first wall has an inner concave surface, an outer convex surface, and a second longitudinal axis; and, has at least one pair of spaced apart clips connected to and extending outwardly from the inner concave surface normal to the second longitudinal axis.

The scent-introduction method of the invention also includes providing a second arcuate generally semi-cylindrical wall having an inner concave surface, an outer convex surface and a third longitudinal axis; and includes manually mounting the first wall on the lower portion of the trunk by displacing the first wall in a direction of travel generally perpendicular to the first longitudinal axis such that the pair of clips engage and extend generally normal to and at least partially around the trunk to secure the first wall on the trunk, and the first wall partially circumferentially extends around the lower portion of the trunk.

The scent-introduction method of the invention also includes the steps of manually removably securing the second wall to the first wall such that the first and second walls collectively extend substantially entirely around the trunk; and, includes concealing air freshener within the first and second walls, and intermediate at least one of the walls and the trunk.

Turning now to the drawings, which illustrate the presently preferred embodiments of the invention by way of explanation and not limitation, and in which like reference characters refer to corresponding elements throughout the several views, FIG. 1 illustrates a system constructed in accordance with the invention and including an air freshener container generally indicated by reference character 10. Container 10 includes a first arcuate generally semi-cylindrical wall 11 and a second arcuate generally semi-cylindrical wall 12. Wall 11 includes inner concave surface 11A, an outer convex surface 11B, and a first longitudinal axis L1 (FIGS. 2 and 3). Wall 12 includes inner concave surface 12A, an outer convex surface 12B, and a second longitudinal axis L2 (FIG. 3). In FIG. 2, the first and second longitudinal axes are each perpendicular to the plane of the sheet of paper on which FIG. 2 is inscribed. In FIG. 3, the trunk 61 of an erected Christmas tree 60 has a vertically oriented third longitudinal axis which is generally perpendicular to the ground or floor on which the Christmas tree is erected. Further, in FIGS. 2 and 3 the first and second longitudinal axes (of walls 11 and 12, respectively) are parallel to the third longitudinal axis, where the third longitudinal axis comprises the longitudinal axis of trunk 61.

A first pair of spaced apart resilient spring metal clips 13A, 13 is fixedly connected to and extends outwardly from the inner concave surface 11A of wall 11. Clip 13A includes end 17 connected to surface 11A, includes intermediate section 18 (FIG. 2), and includes distal tip 19. Clip 13 includes proximate end 14 connected to surface 11A, includes intermediate section 15, and includes distal tip 16.

Clips 13A and 13 are shaped and dimensioned and spaced apart such that when wall 11 is manually held in the orientation of FIG. 3 and moved in a direction A that is normal to the longitudinal axis of trunk 61 of Christmas tree 60, distal tips 16 and 19 initially contact and slide over trunk 61 of Christmas tree 60 to spread apart clips 13A and 13. Wall 11 continues to be pushed manually in the direction of arrow A until arcuate intermediate sections 15 and 18 seat on and generally conform to portions of the exterior of trunk 16 in the manner illustrated in FIG. 1. FIG. 2 illustrates the first operative stowed position of clips 13A and 13, wherein clips 13A, 13 are not resiliently separated by trunk 61. FIG. 1 illustrates the second operative deployed “spread” position of clips 13A and 13. In FIG. 1, clips 13A and 13 secure wall 11 to trunk 61.

A second (or third, or fourth, etc.) pair of resilient spring metal clips, including clip 20, is also, if desired, provided and each of the second pair of clips is fixedly connected to and extend outwardly from the inner concave surface 11A of wall 11. The second pair of clips presently has a shape and dimension and spacing (between said second pair of clips) equivalent to that of clips 13A and 13, although such is not necessary. The second one of the second pair of clips is not visible in FIG. 1; only clip 20 is visible. The second pair of clips is spaced apart from clips 13A and 13.

The shape and dimension and material utilized to construct each clip in a clip pair can vary as desired. Further, if desired, means other than clip pair 13A, 13 can be utilized to secure removably wall 11 to the trunk 61 of a Christmas tree 60. Clip pair 13A and 13 is, however, presently preferred to attach wall 11 to trunk 61 because clip pair 13A, 13 does not require the use of tools to attach wall 11 to trunk 61.

In FIG. 1, wall 11 partially circumferentially extends around trunk 61. Wall 12 includes outwardly extending nipples 40 and 42 (FIG. 2). When wall 12 is joined to wall 11 in the manner illustrated in FIG. 1, nipples 40 and 42 are slidably frictionally removably received by apertures 41 and 43 (FIG. 2), respectively, formed in wall 11. When walls 11 and 12 are joined in the manner illustrated in FIG. 1, walls 11 and collectively extend substantially entirely around trunk 61. The frictional or other engagement between nipples 40 and 42 and apertures 41 and 43 (i.e., between walls 11 and 12) is sufficient to maintain wall 12 in place adjacent wall 11 in the manner illustrated in FIG. 1. The width D (FIG. 5) of the assembled walls 11 and 12 is greater than the diameter of trunk 61.

Cup 31 is connected to and outwardly extends from inner surface 12A (FIGS. 1 and 2). If desired, cup 31 can be heated, either by heat generated by burning propane or another composition, or with electrical resistance elements. In FIG. 5, electrical outlet 70 can receive the male end of an electrical cord. Cup 31 includes an electrically powered heat-producing resistance element. Outlet 70 is connected to cup 31 and to the resistance element (not shown) which heats cup 31 and heats a liquid, semi-liquid, or solid fragrance in cup 31. Outlet 70 can alternatively be shaped and dimensioned to receive the female end of an electrical cord.

Wall 11 includes outwardly extending support arms 25 and 27 fixedly connected to inner concave surface 11A. Wall 12 includes outwardly extending support arms 29 and 30 fixedly connected to inner concave surface 12A.

The support shelf 50 (FIGS. 2 and 4) can be shaped and dimensioned to be inserted on support arms 25 and 27 in the manner illustrated in FIG. 4. Shelf 50 includes orthogonal apertures 51, 52 formed therethrough to receive slidably removably the upstanding feet 26, 28, respectively, of support arms 25 and 27.

Christmas tree 60 includes a trunk 61 with a lower portion and an upper portion. The upper portion includes a plurality of branches extending outwardly from trunk 61. The lower portion generally does not include branches extending outwardly from trunk 61. The lower portion of the trunk 61 typically extends into a Christmas tree stand 62 which supports tree 60. The lower portion of the trunk also typically extends a distance above the Christmas tree stand. Walls 11 and 12 are preferably mounted on the lower portion of trunk 61 above points at which stand 62 contacts and/or supports trunk 61 of Christmas tree 60. Tree 60 includes a plurality of Christmas tree lights 63 and/or of other decorations such as candy canes 64, popcorn strands, 66, and spherical ornaments 65. When a cut live coniferous tree or an undecorated artificial coniferous tree is utilized in the practice of the invention, placing decorations on the tree comprises manually mounting the decorations on the tree by stringing lights about the tree, placing tinsel on the tree, hanging ornaments on the tree, etc. after the Christmas tree is erected in a tree stand. When a pre-decorated artificial tree (i.e., when the tree is purchased it is purchased with decorations already on the tree) is utilized in the practice of the invention, placing decorations on the tree is deemed to occur when the tree is erected in a tree stand.

As is illustrated in FIG. 5, each wall 11, 12 can include lines of perforation, or weakening, so that segments of each wall 11, 12 can be broken off or otherwise detached to shorten the length of wall 11, 12.

The exterior convex surfaces 11B, 12B can, if desired, be textured and/or colored to resemble a natural tree bark.

An freshener packet 17 can be placed in cup 31, on a shelf 50, or hung inside walls 11, 12. Packet 17 can, if desired, include a gel fragrance, be partially or completely saturated with a liquid fragrance, or can include any other means of producing a fragrance which is released from freshener packet 17 into the ambient air.

Since walls 11 and 12 are not required to erect a coniferous tree in a tree stand and to decorate the coniferous tree to produce a Christmas tree, walls 11 and 12 can be mounted on the trunk of a Christmas tree at any desired time after a coniferous tree is erected and decorated to produce a Christmas tree. Further, while it is presently assumed that walls 11 and 12 would be mounted on the trunk of a Christmas tree after the tree is erected, it is possible, if desired, to mount walls 11 and 12 on the trunk of a coniferous tree prior to erecting and decorating the tree to produce a Christmas tree.

Walls 11 and 12 comprise a retrofit and are not part of the trunk or another portion of an original live coniferous tree that is cut to be decorated and produce a Christmas tree. Although the exterior of the walls may be formed to produce a color(s) or bark-like appearance to camouflage walls 11, 12, walls 11 and 12 are not intended to serve as a Christmas decoration for a tree. The intent is to disguise the presence of walls 11, 12. Since walls 11 and 12 are preferably mounted at the base of the tree adjacent, or possibly within, a tree stand, walls 11 and 12 normally are concealed from the sight of an upright individual, either by tree branches or by decorations on the tree.

Similarly, since walls 11 and 12 comprise a retrofit, they normally are not intended to be part of the trunk or another portion of an artificial coniferous tree that is to be erected and decorated to produce a Christmas tree. Although the exterior of the walls may be formed to produce a color(s) or bark-like appearance to camouflage walls 11, 12, walls 11 and 12 are not intended to serve as a Christmas decoration for a tree. The intent is to disguise the presence of walls 11, 12. Since walls 11 and 12 are preferably mounted at the base of the artificial tree adjacent, or possibly within, a tree stand, walls 11 and 12 normally are concealed from sight of an upright individual, either by tree branches or by decorations on the tree.

It is possible, if desired, to mount walls 11 and 12 on the trunk 61 of a tree at a location on the upper portion of the tree, where the upper portion includes branches outwardly extending from the trunk. In such a case, walls 11 and 12 would still comprise a retrofit, and normally would not intended to be part of the trunk or another portion of a tree that is to be erected and decorated to produce a Christmas tree. Nor would walls 11 and 12 be intended to serve as a decoration for the tree. Walls 11 and 12 normally would be concealed from sight of an upright individual, either by tree branches or by decorations on the tree.

Walls 11, 12 are not intended to comprise structural support for the trunk or branches of a live or artificial coniferous tree. This is, in part, the case because walls 11 and 12 ordinarily are spaced apart from a trunk 61 in order to provide room for an air freshener to be inserted between a trunk 61 and walls 11 and 12. Clips 13A and 13 function to secure walls 11 and 12 on trunk 61. Clips 13A and 13 are not intended to provide structural support for trunk 61. While it might be argued that the resilient clips “squeeze” the trunk and therefore provide structural support, such structural support is viewed as minuscule and insignificant. Similarly, if the clips were screwed into the trunk, any so-called “structural support” would be deemed minuscule and insignificant. Walls 11 and 12 and the fastening means used to removably secure walls 11 and 12 to trunk 61 are not intended to provide any significant structure support to a live or artificial coniferous tree.

Nor are walls 11, 12 necessary to erect and decorate an original live or artificial coniferous tree to produce a Christmas tree. As used herein, a live coniferous tree is a coniferous tree which had roots in soil and grew naturally; which was cut to be erected and decorated to serve as a Christmas tree; and, which was a living tree at the time it was cut.

Walls 11, 12 obviously are not integral part of the trunk of a live coniferous tree because they are not living things. The live coniferous tree grew without walls 11, 12. Similarly, walls 11 and 12 are not part of the trunk of an artificial coniferous tree because they are not utilized to construct an artificial tree which can be erected and decorated to produce a Christmas tree. If a live or artificial coniferous tree is viewed as OE (original equipment), walls 11 and 12 are not part of the original equipment and are not a necessary part of the original equipment. Walls 11 and 12 and the other structural components of the invention connected to or associated with walls 11 and 12 are used to mount and disguise the presence of a scent producing composition and not to produce an artificial Christmas tree. Walls 11 and 12 comprise an auxiliary retrofit for an artificial Christmas tree or for a Christmas tree produced using a live coniferous tree.

The presently preferred air freshener container 10 of the invention includes a pair of walls 11, 12 which can be assembled to circumscribe the trunk of a Christmas tree. As would be appreciated by those of skill in the art, container 10 can, if desired, utilize three or more walls or components which can be assembled to circumscribe partially or generally completely the trunk of a Christmas tree.

1. A system to introduce a scent into the ambient air, said system comprising
(a) a coniferous generally conically shaped Christmas tree comprising
(i) a trunk with an upper portion having a plurality of outwardly extending branches, and a lower portion free of outwardly extending branches, said trunk having a generally vertically oriented longitudinal axis, and
(ii) a plurality of decorations on said tree including Christmas tree lights;
(b) a Christmas tree stand receiving said trunk and supporting said Christmas tree;
(c) a first arcuate generally semi-cylindrical wall having an inner concave surface and an outer convex surface;
(d) at least one pair of spaced apart clips
(i) connected to and extending outwardly from said inner concave surface normal to said longitudinal axis of said trunk, and
(ii) engaging said lower portion of said Christmas tree trunk to removably secure said first wall to said trunk such that said first wall partially circumferentially extends around said lower portion of said trunk;
(e) a second arcuate generally semi-cylindrical wall having an inner concave surface and an outer convex surface and removably connected to said first wall such that first and second walls collectively extend substantially entirely around said trunk; and,
(f) air freshener concealed
(i) within said first and second walls, and
(ii) intermediate at least one of said walls and said trunk.

2. A method to introduce a scent into the ambient air, said method comprising the steps of
(a) providing a coniferous generally conically shaped tree comprising a trunk with an upper portion having a plurality of outwardly extending branches, and a lower portion free of outwardly extending branches, said trunk having a generally vertically oriented first longitudinal axis, and
(b) providing a plurality of Christmas tree decorations including Christmas tree lights;
(c) providing a Christmas tree stand to receive said trunk and support said coniferous tree;
(d) mounting said coniferous tree in said Christmas tree stand;
(e) placing said Christmas tree decorations on said coniferous tree to produce a Christmas tree;;
(f) providing a first arcuate generally semi-cylindrical wall having
(i) an inner concave surface, an outer convex surface, and a second longitudinal axis,
(ii) at least one pair of spaced apart clips connected to and extending outwardly from said inner concave surface normal to said second longitudinal axis, and
(g) providing a second arcuate generally semi-cylindrical wall having an inner concave surface, an outer convex surface and a third longitudinal axis;
(h) manually mounting said first wall on said lower portion of said trunk by displacing said first wall in a direction of travel generally perpendicular to said first longitudinal axis such that
(i) said pair of clips engage and extend generally normal to and at least partially around said trunk to secure said first wall on said trunk, and
(ii) said first wall partially circumferentially extends around said lower portion of said trunk;
(i) manually removably securing said second wall to said first wall such that said first and second walls collectively extend substantially entirely around said trunk; and,
(j) concealing air freshener
(i) within said first and second walls, and
(ii) intermediate at least one of said walls and said trunk.
